(19) United States
(12) Patent Application Publication
(10) Pub. No.: US 2013/0056894 A1
(43) Pub. Date: Mar. 7, 2013

(54) METHOD FOR MANUFACTURING CRASH PAD FOR VEHICLES

(71) Applicants: Myoung Ryoul Lee, Hwaseong (KR); Byoung Seok Kong, Gunpo (KR)

(72) Inventors: Myoung Ryoul Lee, Hwaseong (KR); Byoung Seok Kong, Gunpo (KR)

(73) Assignees: KIA MOTORS CORPORATION, Seoul (KR); HYUNDAI MOTOR COMPANY, Seoul (KR)

(21) Appl. No.: 13/299,577

(22) Filed: Nov. 18, 2011

(30) Foreign Application Priority Data
Sep. 1, 2011 (KR) 10-2011-0088747

(51) Int. Cl. B29C 47/76; B29C 71/02; B29C 41/42

(52) U.S. Cl. 264/101; 264/334; 425/405.1; 425/447

(57) ABSTRACT

Disclosed is a method for manufacturing a crash pad for vehicles. In the method, a surface material is inserted into an upper mold. A base material of a liquefied resin is supplied through a loading aperture of a lower mold. A shape of a molded product of the crash pad including the surface material and the base material is maintained by combining the upper mold and the lower mold together and then cooling thereafter. The molded product is taken out from a mold after separating the upper mold from the lower mold.

### CROSS-REFERENCE TO RELATED APPLICATION

This application claims under 35 U.S.C. §119(a) the benefit of Korean Patent Application No. 10-2011-0088747 filed Sep. 1, 2011, the entire contents of which are incorporated herein by reference.

### BACKGROUND

(a) Technical Field

The present invention relates to a method for manufacturing a crash pad for vehicles. More particularly, it relates to a method for manufacturing a crash pad for vehicles through rear low-pressure injection-molding.

(b) Background Art

Generally, a vacuum molding process and a powder molding process (e.g., powder slush molding) are widely used in manufacturing of crash pads for vehicles to which soft foam skin is applied. However, the above processes are costly due to expensive manufacturing processes and numerous process steps thereof. Therefore, it is difficult to economically justify their application low-cost vehicles.

Accordingly, a hard plastic type crash pad is being applied to low-priced vehicles. However, since this type of crash pad has little texture, and has much need for improvement in quality, especially seeing that soft foam is so effective

In order to improve the quality of the hard-type crash pad, as shown in FIG. 1, a process has been developed in which polypropylene foam 3 is laminated on thermoplastic olefin skin 2 to form a surface material 1, and then the surface material 1 and a polypropylene base material are bonded to and laminated on each other.

Referring to FIG. 2, in a method for manufacturing a crash pad using soft foam skin, the surface material 1 is inserted into a mold, and is pre-heated for vacuum molding, and then a base material 5 is injection-molded at a lower temperature from a separate mold 6. Thereafter, an adhesive is coated on the base material 5, and then the surface material 1 and the base material 5 are bonded to each other. Finally, products are taken out of the mold through a piercing process.

However, in the above process, a bonding process between the surface material 1 and the base material 5 is necessary and takes quite a long time to complete. Furthermore, the bonding process is harmful to environment due to the use of a separate oil-based adhesive. To overcome the above limitation, it is possible to insert a surface material in which polypropylene foam is laminated on thermoplastic olefin skin into a mold and then integrally form a base material.

Hereinafter, a method for manufacturing a crash pad through rear low-pressure injection molding according to a related art will be described with reference to FIG. 3.

The surface material 1 is inserted into the mold 6, and, when the mold 6 is opened, a molten resin 5, having a temperature of about 150° C. and including compositions such as polypropylene and thermoplastic olefin, is injected onto the rear side of the surface material 1 at a low temperature. Thereafter, when the mold 6 is closed, the molten resin 5 that has been injection-molded at a low temperature is compressed on the polypropylene foam 3 of the surface material 1 to integrally form the base material 5 and the surface material 1. However, when the heat-resistance of the polypropylene foam 3 of the surface material 1 to which the molten resin 5 is injection-molded is low, rupture, depression, and bending may occur on the surface material 1, deteriorating the exterior of the surface material 1. On the other hand, when the heat-resistance of the polypropylene foam 3 is high, there is no rupture or depression but the surface quality such as its cushion or softness may be reduced.

In addition, as shown in FIG. 4, the polypropylene foam 3 may be melted and compressed by the heat and injection pressure of the molten resin 5. Accordingly, the thickness of the polypropylene foam 3 may be reduced to a ratio of about 0.6 or less after the molding than before the molding, and the recovery rate of the foam may be reduced. Generally, since two or more gates 7 are dispersedly disposed to injection-mold these large parts (e.g., a crash pad, gas generated from the molten resin 5 as shown in FIG. 5 may concentrate between the gates 7 during compression by the mold 6. In this case, surface swelling such as bending may occur at an interface between the surface material 1 and the base material 5.

For this reason, polyethylene foam or thermoplastic olefin foam may be used in a foam layer instead of polypropylene foam to improve the surface quality (e.g., cushion and softness). In this case, however, rupture or depression may increase. Also, cloth can be used in the foam layer instead of polypropylene foam. However, the structure of the surface cloth may be transcribed on the surface after the molding, deteriorating the exterior and reducing the perceived quality. When a thermoplastic olefin protection film is laminated on an injection surface of foam to prevent the rupture or bending of foam of good surface quality, the flow of high-temperature resin from the injection gate part may be deteriorated, increasing surface bending after the rear low-pressure injection molding.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a method for manufacturing a crash pad for vehicles, which reduces manufacturing time and complexity by integrally forming a base material through low pressure injection molding without a separate bonding process after inserting a surface material into a mold.

The present invention also provides a method for manufacturing a crash pad for vehicles, which minimizes the damage of a surface material and maximizes the recovery rate of the surface material by minimizing the pressure and heat applied to a polypropylene foam (soft foam) during integral formation of a base material and the surface material using a high-density foam layer under the soft foam of the surface material, and prevents swelling of the exterior of a surface material by absorbing gas generated from a molten resin of the base material.

In one aspect, the present invention provides a method for manufacturing a crash pad for vehicles, including: inserting a surface material into an upper mold; supplying a base material of a liquefied resin through a loading aperture of a lower mold; maintaining a shape of a molded product of the crash pad including the surface material and the base material by combining the upper mold and the lower mold together and then cooling thereafter; and removing the molded product from a mold after separating the upper mold from the lower mold.

In an exemplary embodiment, the method may further include vacuum-compressing the surface material on an internal surface of the upper mold by releasing air inside the upper mold through an air outlet of the upper mold before supplying the base material after inserting the surface material.

In another exemplary embodiment, the surface material may include a surface layer and a foam layer laminated on a rear surface of the surface layer. The foam layer may include an upper layer contacting the real surface of the surface layer and having a low-density structure, and a lower layer of a high-density structure to which a molten resin is injected. The lower layer may block heat and pressure of the molten resin.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view illustrating a surface material of a crash pad for vehicles according to a related art;

FIG. 2 is a schematic view illustrating an exemplary method for manufacturing a crash pad for vehicles according to a related art;

FIG. 3 is a schematic view illustrating another exemplary method for manufacturing a crash pad for vehicles according to a related art;

FIG. 4 is a photograph illustrating a surface material compressed by pressure and heat of a molten resin in the related art;

FIG. 5 is a schematic view illustrating swelling of a surface material caused gas concentration in a related art;

FIG. 6 is a schematic view illustrating a method for manufacturing a crash pad for vehicles according to an exemplary embodiment of the present invention;

FIG. 7 is a cross-sectional view illustrating a structure of a crash pad for vehicles according to an exemplary embodiment of the present invention;

FIG. 8 is a view illustrating a method for manufacturing a crash pad for vehicle according to an exemplary embodiment of the present invention; and

FIG. 9 is a cross-sectional view illustrating absorption of gas generated from a molten resin at a lower layer of a foam layer during molding compression.

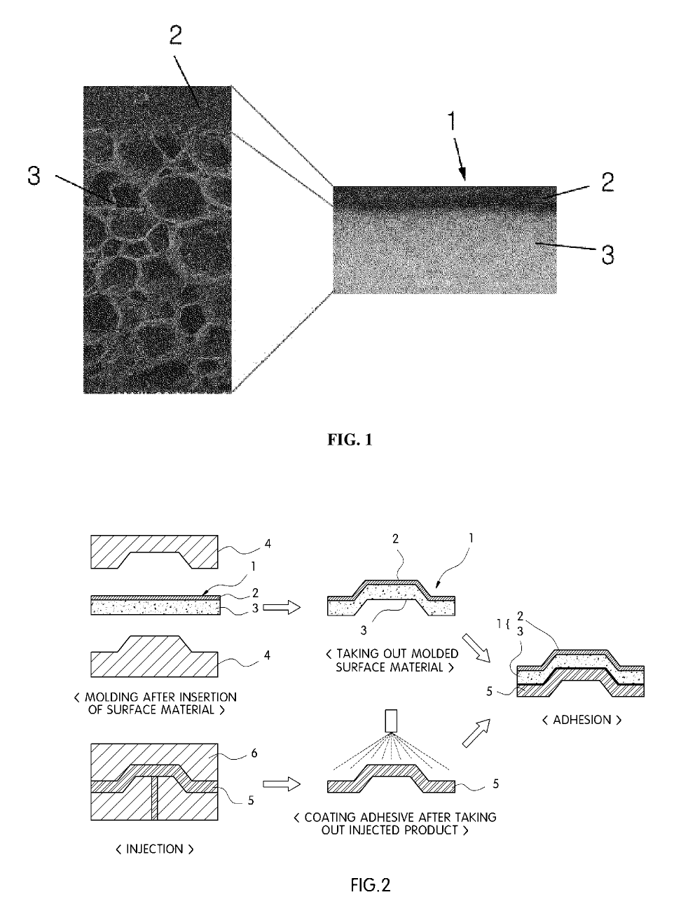

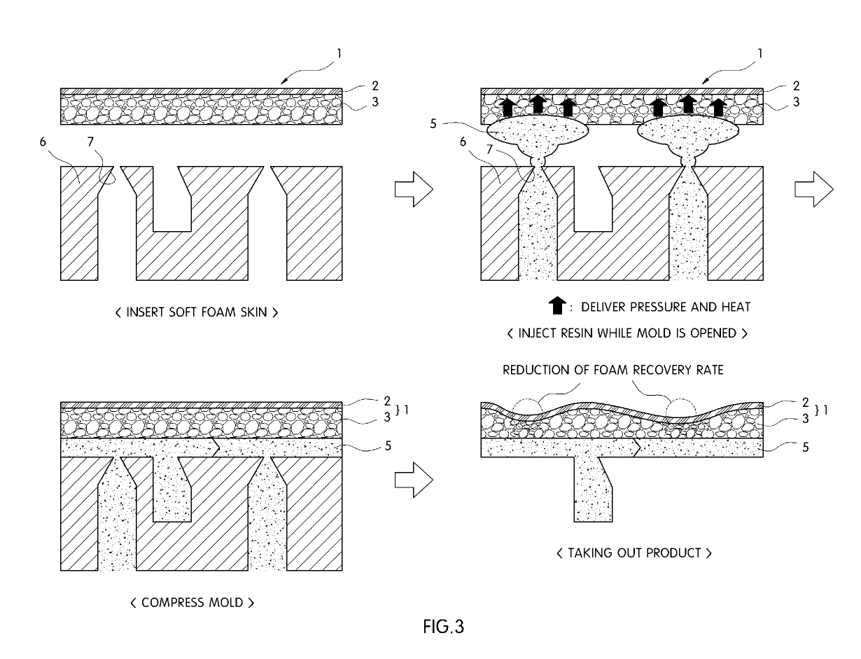

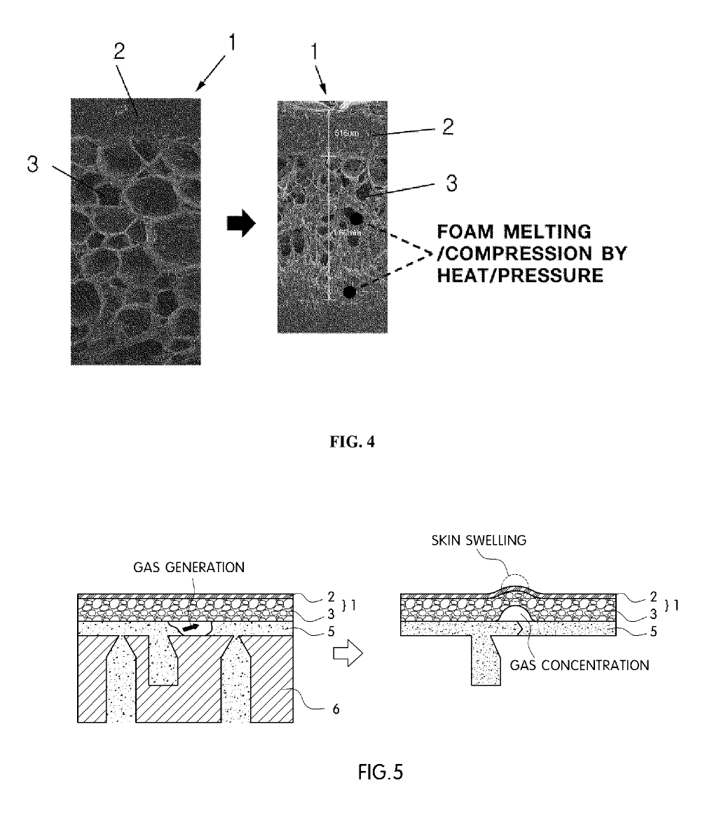

Reference numerals set forth in the Drawings includes reference to the following elements as further discussed below:
10: surface material
11: surface layer
12: upper layer
13: lower layer
14: mold
14a: upper mold
14b: lower mold
15: gate
16: base material
17: air outlet
18: foam layer

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

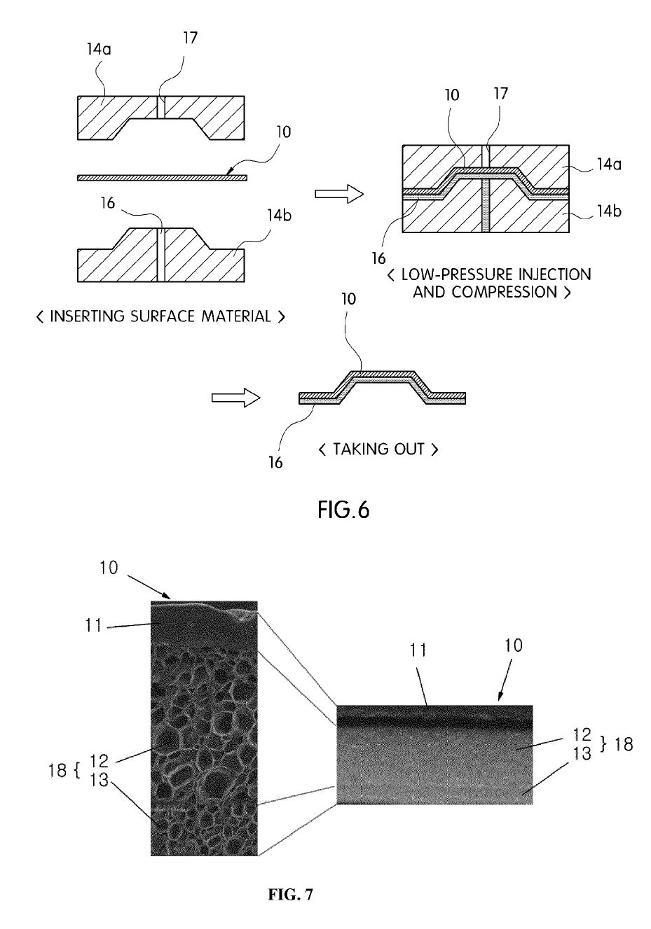

FIG. 6 is a schematic view illustrating a method/process for manufacturing a crash pad for vehicles according to an embodiment of the present invention. FIG. 7 is a cross-sectional view illustrating a structure of a crash pad for vehicles according to an embodiment of the present invention. The present invention relates to a method for manufacturing a crash pad for vehicles, which improves heat-resistance of a surface material 10 and satisfies both the exterior quality and the perceived quality by manufacturing a crash pad through rear low-pressure injection-molding. By perceived quality it is meant the degree of cushion or softness which a surface exhibits or the degree to which a material yields to pressure or weight.

The method for manufacturing a crash pad may include inserting a surface material 10 into a mold, injection-molding a base material 16 at a low pressure, and removing a product. First, the surface material 10 may be inserted into an upper mold 14a. In this case, the surface material 10 may be pre-heated if necessary. The surface material 10 of the crash pad may include a surface layer 11 and a foam layer 18. The foam layer 18 may be formed to have a multi-layer structure, thereby overcoming depression, bending, and rupture of the surface during injection molding and improving the surface perceived quality (e.g., degree of cushion or softness) even after the injection molding. Thus, the surface material 10 is both heat-resistive and of high perceived quality, both of which are problems in the previous designs discussed above.

For this, the foam layer 18 disposed on the other side of the surface layer 11 may include two or more types of olefin polymer-based foam that have different foaming ratios or types and are stacked on each other. The types of olefin polymer-based foam may include olefin-based thermoplastic elastomer (TPE) including at least one of polypropylene, polyethylene, polypropylene copolymer or terpolymer including C₂ or C₄˜C₁₂-α-olefins, and polyethylene copolymer or terpolymer including C₂ or C₄˜C₁₂-α-olefins. Also, the olefin polymer-based foam may include at least one of styrene-based TPE, urethane-based TPE, ester-based TPE, amide-based TPE, and vinyl acetate-based TPE at a content of 50% or less to improve the physical properties of a sheet.

When the foam layer 18 is configured to have a multi-layer including an upper layer 12 and a lower layer 13, the lower layer 13 contacting an injection resin 16 may include foam having a high heat-resistance, and the upper layer 12 combined with the surface material 10 to thereby affect the perceived quality may include foam having a better perceived quality such as increased cushion characteristics.

As shown in FIG. 7, the surface material 10 of the crash pad for vehicles according to the embodiment may include the surface layer 11 and the foam layer 18. In this case, the surface layer 11 may include one of thermoplastic olefin sheet, polyvinyl chloride sheet, PVC alloy sheet, and polyurethane sheet, which are commonly used as interior materials for vehicles.

The TPO sheet may include olefin-based thermoplastic elastomer (TPE) including at least one of polypropylene, polyethylene, polypropylene copolymer or terpolymer including C₂ or C₄˜C₁₂-α-olefins, and polyethylene copolymer or terpolymer including C₂ or C₄˜C₁₂-α-olefins. The TPO sheet may include at least one of styrene-based TPE, urethane-based TPE, ester-based TPE, amide-based TPE, and vinyl acetate-based TPE at a content of about 0.1 wt % to about 50 wt % to improve the physical properties of a sheet, and may further include an irradiation cross linking process to improve the emboss maintenance and the surface abrasion characteristics. In this case, scratch-resistance, durability, chemical-resistance, and abrasion-resistance can be further improved by further coating chlorinated polypropylene-based resin, acryl-based resin, and urethane-based resin on the surface of the surface layer 11.

The foam layer 18 may be formed in a multi-layer, and in this embodiment, may have a multi-layer structure including an upper layer 12 and a lower layer 13. However, the foam layer 18 may have three layers including an upper layer 12, an intermediate layer, and a lower layer 13, or more. Particularly, when the foam layer 18 is formed in a multilayer, foams having different foaming ratios or types may be used. Since the upper layer 12 is combined with the surface material 10 constituting the surface layer 11 and the affects the perceived quality, the upper layer 12 may be formed using PP/PE/TPO foam for vacuum molding.

Also, since the lower layer 13 comes in contact with a high-temperature injection resin 16, the lower layer 13 may be formed using PP foam for injection-molding, which has an excellent heat-resistance. For this, TPE foam may be used as the foam layer 18. Particularly, the foam may include olefin-based thermoplastic elastomer (TPE) including at least one of polypropylene, polyethylene, polypropylene copolymer or terpolymer including C₂ or C₄˜C₁₂-α-olefins, and polyethylene copolymer or terpolymer including C₂ or C₄˜C₁₂-α-olefins. Also, the foam may include at least one of styrene-based TPE, urethane-based TPE, ester-based TPE, amide-based TPE, and vinyl acetate-based TPE at a content of 50% or less to improve the physical properties of a sheet.

Also, the upper layer 12 may be foamed at a ratio of about 5 to about 50 to improve the perceived quality during injection-molding, and the lower layer 13 may be foamed at a ratio of about 1 to about 30 to improve the heat-resistance.

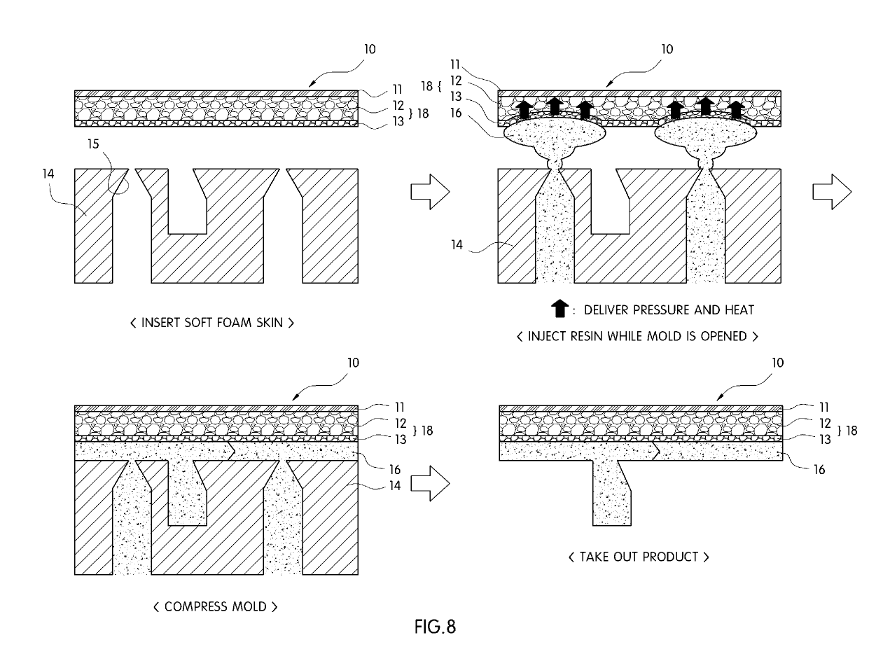

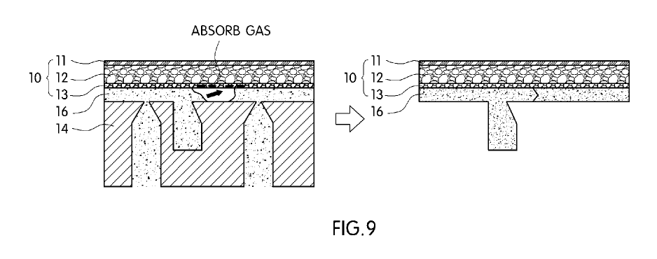

FIG. 8 is a view illustrating a method for manufacturing a crash pad for vehicle according to an exemplary embodiment of the present invention. FIG. 9 is a cross-sectional view illustrating absorption of gas generated from a molten resin at a lower layer of a foam layer during molding compression. Here, the foaming ratio relates to the density of the foam. The foaming ratio is in inverse proportion to the density.

The upper layer 12 may be formed with a low-density foam structure to increase the surface perceived quality of a crash pad. The lower layer may be formed with a high-density foam structure to block heat and pressure of a molten resin 16 injected onto the surface material 10 during injection-molding. Thus, the thickness of the foam layer 18 can be preserved, and the deviation of the thickness according to locations of the foam layer 18 can be minimized. Also, the recovery rate of the foam can be increased due to the high-density foam layer 18. For example, the improvement of the recovery rate of the foam layer 18 due to the lower layer 13 of the high-density structure shows that the thickness of the foam layer 18 after molding increases about 0.8% or more compared to that before molding.

The lower layer 13 of the high-density structure may absorb gas generated from the molten resin 16 to prevent swelling and bending of the surface material 10 due to gas concentration between existing gates. The material of the high-density foam may include a PP foam material or a polar polymer material identical to the base material 16 for smooth joining with the base material 16, and may include a material containing homo-PP by about 10 wt % or more to improve the heat-resistant effect of the product. In addition, the foaming thickness of the upper layer 12 may range from about 0.5 mm to about 9.5 mm so as not to affect the surface perceived quality, and the lower layer 13 may also range from about 0.5 mm to about 9.5 mm to endure the temperature of injected resin.

The foaming ratio, material type, and thickness may vary according to the molding conditions of the injected resin and the surface perceived quality satisfaction. Particularly, the thickness of the foaming layer 18 including the upper layer 12 and the lower layer 13 may range from about 1 mm to about 10 mm. The reason why the thickness of the foam layer 18 is limited to the above range is that when the thickness of one layer becomes 0.5 mm that is the minimum maintenance condition of the foam layer 18. For example, if the upper layer 12 is maintained under about 0.5 mm, the surface perceived quality may be reduced when combined with the surface material 10. Additionally, if the lower layer 13 is maintained under about 0.5 mm, it cannot endure the temperature (about 150° C. to about 250° C.) of the injected resin 16, which may incur bending, depression, and rupture during the injection-molding. Accordingly, the foam layer 18 must have a thickness of about 1 mm or more. More specifically, in the above example, the 1 mm range relates to the thickness of the foam layer 18, which consists of two layers (i.e., the upper layer 12 and the lower layer 13). Therefore, one half of 1 mm, i.e., 0.5 mm becomes the new range for the upper layer or the lower layer individually.

When the thickness of the foam layer 18 exceeds about 10 mm, reduction of sharpness of a corner part after molding, deviation from other assemblies, and rises in costs may occur. Accordingly, the foam layer 18 must have a thickness of about 10 mm or less.

The injected resin (molten resin 16 for base material) may be injected onto an undersurface of the lower surface layer 13, i.e., the foam layer 18 of the surface material 10 through the gate 15 of an injection machine in a state where the injected resin is melted at a temperature of about 150° C. to about 250° C. Furthermore, since the foam cannot be injected in different foam ratios and materials at the same time, a separate combining process is required to laminate different foams. The laminating method may include thermal laminating, adhesive laminating, and hot-melt-type laminating, most preferably, thermal laminating.

When the surface layer 11 is combined with the upper layer 12 of the foam layer 18 through thermal laminating, the temperature of the surface layer 11 directly before the laminating has to be maintained at least about 50° C. to about 300° C. to prevent foliation after molding. The surface material 10 may be inserted into an upper mold 14a, and then, if necessary, the internal air of the upper mold 14a may be exhausted to allow the surface material 10 to be vacuum-compressed on a target surface inside the upper mold 14a and simultaneously supply the base material 16 of a liquefied resin state to an upper surface through a lower mold 14b. When the mold 14 is in an open state, the liquefied resin 16 may be injected onto the surface material 10 through the gate 15. Here, an air outlet 17 may be formed in the upper mold 14a to exhaust air. When air inside the upper mold 14a is exhausted by a vacuum pump (not shown), the surface material 10 may be vacuum-compressed on the undersurface of the upper mold 14a.

Also, a hot runner nozzle is disposed in the lower mold 14b to supply the base material 16 of a liquefied resin, and the base material 16 of the liquefied resin supplied from the hot runner nozzle may include PP or TPO resin that is olefin resin, but embodiments are not limited thereto.

Next, the upper mold 14a may be downwardly combined with the lower mold 14b. Here, the liquefied resin 16 supplied to the lower mold 14b may be formed into a mold shape of the mold 14 to form the base material 16, and also integrally formed with the surface material 10 that is not yet cooled, without a separate adhesive.

Thereafter, the upper mold 14a may rise and the formed crash pad part may be separated from the lower mold 14b. The crash pad part may be processed through piercing so as to have a proper size, thereby taking out an interior material that has been completely molded. Here, the piercing process may be identical to a typical piercing process used for molding of an interior material for vehicles, and detailed description thereof will be omitted.

Hereinafter, the present invention will be described in more detail based on the following embodiment, but the present invention is not limited thereto.

### EXAMPLE

The following examples illustrate the invention and are not intended to limit the same. A crash pad for vehicles according to an embodiment may include a surface layer 11 and a foam layer 18. The surface layer 11 may be configured by the same method as a typical method, and the foam layer 18 may be manufactured in a structure in which the upper layer 12 formed of PP/PE/TPO foam material for vacuum molding, having a high foaming ratio (e.g., about 15 or more) is laminated on the lower layer 13 formed of PP foam material for injection molding, having a lower ratio (e.g., about 15 or less) and a high heat-resistance.

### Test Example 1

The lower layer of the foam layer is formed with the same multilayer structure as Embodiment 1 except that the lower layer is formed of TPO/PP/PE sheets.

### Test Example 2

The foam layer is formed in a single layer structure of PP foam for injection molding, and the surface layer is formed using the same configuration as a typical one.

### Test Example 3

The foam layer is formed in a single layer structure of PP/PE/TPO foam for vacuum molding, and the surface layer is formed using the same configuration as a typical one.

### Test Example 4

The foam layer is formed in a single layer of cloth (e.g., nonwoven, fabric, etc), and the surface layer is formed using the same configuration as a typical one.

In order to check the rupture, depression, bending, thickness deviation, and surface perceived quality characteristics after injection molding, a sample of the same size and condition was manufactured, and the characteristics were verified during the above process, and the result thereof is expressed as Table 1.

TABLE 1

| | | | Surface exterior | |
|---|---|---|---|---|
| | | | after injection | Surface perceived |
| | | Rupture/depression | molding (surface | quality after |
| | Type of foam | during injection | bending, thickness | injection molding |
| Division | layer | molding | deviation) | (cushion/softness) |
| Example | Upper layer: | ◯ | ◯ | ◯ |
| | PP/PE/TPO foam | | | |
| | for vacuum | | | |
| | molding | | | |
| Test Example 1 | Upper layer: | ◯ | X | ◯ |
| | PP/PE/TPO foam | | | |
| | for vacuum | | | |
| | molding | | | |
| Test Example 2 | PP foam for | ◯ | ◯ | X |
| | injection molding | | | |
| | (high | | | |
| | heat-resistance, | | | |
| | low ratio: 15 or | | | |
| | less) | | | |
| Test Example 3 | PP/PE/TPO foam | X | X | ◯ |
| | for vacuum | | | |
| | molding (high | | | |
| | ratio: 15 or more) | | | |
| Test Example 4 | Cloth (nonwoven, | ◯ | X | X |
| | fabric, etc.) | | | |

In Table 1, O represents that there are no rupture, depression, surface bending and thickness deviation, and the surface perceived quality is excellent. X means the opposite of O.

As shown in Table 1, the embodiments of the present invention complemented limitations of typical foam layers 18, and verified injection-molding (no rupture and depression), the exterior surface after the injection molding, and the surface perceived quality after the injection molding are good.

In light of the above method, the present invention advantageously reduces manufacturing costs and complexity of the overall process since the surface material and the base material can be bonded without a separate bonding process by integrally forming the base material on the surface material by a rear low-pressure injection-molding method. Furthermore, since a high-density foam layer is inserted between a base material and a surface material of a crash pad to which soft foam is applied, and the high-density foam layer blocks pressure and heat of resin during injection molding, the thickness of the surface material can be preserved, and the deviation of the thickness according to its location can be minimized, thereby improving the recovery rate of the foam. In addition, the high-density foam layer can prevent swelling and bending of the surface material caused by gas concentration between gates in a related art, by absorbing gas generated from a molten resin. Thud, it is possible to improve the exterior of the surface by preventing depression, rupture, and bending of the surface material, and also improve the surface perceived quality such as cushion or softness even after injection molding.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a crash pad for vehicles, comprising:
inserting a surface material into an upper mold;
supplying a base material of a liquefied resin through a loading aperture of a lower mold into the upper mold;
maintaining a shape of a molded product of the crash pad which includes the surface material and the base material by combining the upper mold and the lower mold together and then cooling thereafter; and
removing the molded product from a mold after separating the upper mold from the lower mold.

2. The method of claim 1, comprising vacuum compressing the surface material on an internal surface of the upper mold by releasing air inside the upper mold through an air outlet of the upper mold before supplying the base material after inserting the surface material into the upper mold.

3. The method of claim 1, wherein:
the surface material comprises a surface layer and a foam layer laminated on a rear surface of the surface layer;
the foam layer comprises an upper layer contacting the surface of the surface layer and having a low-density structure, and a lower layer of a high-density structure to which a molten resin is injected; and
the lower layer blocks heat and pressure of the molten resin.

4. The method of claim 3, wherein the surface layer is combined with the upper layer of the foam layer through thermal laminating.

5. The method of claim 4, wherein when the surface layer is combined with the upper layer of the foam layer through thermal laminating, the temperature of the surface layer directly before the laminating is maintained at least about 50° C. to about 300° C.

6. The method of claim 1 further comprising exhausting internal air of the upper mold to allow the surface material to be vacuum-compressed on a target surface inside the upper mold.

7. The method of claim 6 further comprising simultaneously supply the base material of a liquefied resin state to an upper surface through a lower mold at the same time as exhausting.

8. The method of claim 7 wherein when upper mold and the lower mold are not closed to form one mold, the liquefied resin may be injected onto the surface material through a gate.

9. The method of claim 7 wherein an air outlet 17 is formed in the upper mold to exhaust air.

10. The method of claim 7, wherein a hot runner nozzle is disposed in the lower mold to supply the base material of a liquefied resin, and the base material of the liquefied resin supplied from the hot runner nozzle is either polypropylene or thermoplastic olefin resin.

11. A system for manufacturing a crash pad for vehicles, comprising:
an upper mold configured to receive a surface material and a base material of a liquefied resin through a loading aperture in a lower mold
the lower mold configured to receive the base material of a liquefied resin through the loading hole,
wherein a shape of a molded product of the crash pad which includes the surface material and the base material is maintained by combining the upper mold and the lower mold together and then cooling thereafter, and removing the molded product from a mold after separating the upper mold from the lower mold.

12. The system of claim 11, wherein the surface material is vacuum compressed on an internal surface of the upper mold by releasing air inside the upper mold through an air outlet of the upper mold before supplying the base material after inserting the surface material into the upper mold.

13. The system of claim 11, wherein:
the surface material comprises a surface layer and a foam layer laminated on a rear surface of the surface layer;
the foam layer comprises an upper layer contacting the surface of the surface layer and having a low-density structure, and a lower layer of a high-density structure to which a molten resin is injected; and
the lower layer blocks heat and pressure of the molten resin.

14. The system of claim 13, wherein the surface layer is combined with the upper layer of the foam layer through thermal laminating.

15. The system of claim 14, wherein when the surface layer is combined with the upper layer of the foam layer through thermal laminating, the temperature of the surface layer directly before the laminating is maintained at least about 50° C. to about 300° C.

16. The system of claim 11 wherein an air inlet formed in the upper mold is configured to exhaust internal air of the upper mold to allow the surface material to be vacuum-compressed on a target surface inside the upper mold.

17. The system of claim 16 wherein the lower mold is configured to simultaneously supply the base material of a liquefied resin state to an upper surface.

18. The system of claim 17 wherein when upper mold and the lower mold are not closed to form one mold, the liquefied resin may be injected onto the surface material through a gate.

19. The method of claim 17, wherein a hot runner nozzle is disposed in the lower mold and is configured to supply the base material of a liquefied resin, and the base material of the liquefied resin supplied from the hot runner nozzle is either polypropylene or thermoplastic olefin resin.
